(19) United States
(12) Patent Application Publication
(10) Pub. No.: US 2022/0073195 A1
(43) Pub. Date: Mar. 10, 2022

(54) DRIVE APPARATUS AND METHODS FOR USE

(71) Applicant: RADEUS.AERO, INC., Poway, CA (US)

(72) Inventor: Raymond Don Hayden, III, Poway, CA (US)

(21) Appl. No.: 17/364,455

(22) Filed: Jun. 30, 2021

Related U.S. Application Data
(60) Provisional application No. 63/047,056, filed on Jul. 1, 2020.

(51) Int. Cl. B64C 27/10; B64C 27/14; F16H 55/10; F16H 1/32

(52) U.S. Cl. CPC B64C 27/10; F16H 1/32; F16H 55/10; B64C 27/14

(57) ABSTRACT

Methods and apparatus for mechanically driving components in a desired direction, such as in a moving craft. In one embodiment, the craft comprises a vertical or short takeoff and landing (VSTOL) aircraft comprising one or more rotating rings having airfoils disposed around a periphery thereof. In one variant, the one or more rings are driven by a multi-level drive apparatus having a plurality of angularly offset roller-based drive levels and a plurality of corresponding angularly offset driven members (e.g., rings), the plurality of driven members coupled to e.g., the at least one rotating ring. Advantageously, use of this arrangement provides enhanced reliability as well as opportunities for selective load balancing, and obviates comparatively heavy lubrication components such as seals and liquid lubricants, thereby also saving weight when applied to the host craft.

### PRIORITY AND RELATED APPLICATIONS

This application claims priority benefit of U.S. Provisional Patent Application Ser. No. 63/047,056 filed Jul. 1, 2020 and entitled “DRIVE APPARATUS AND METHODS FOR USE” which is incorporated herein by reference in its entirety.

This application is generally related to subject matter contained within co-owned U.S. patent application Ser. No. 13/675,707 filed Nov. 13, 2012 and entitled “Methods and Apparatus for Vertical Short Takeoff and Landing,” Ser. No. 15/179,859 filed Jun. 10, 2016 and entitled “Methods and Apparatus for Vertical Short Takeoff and Landing and Operational Control,” and Ser. No. 15/654,482 filed Jul. 19, 2017 and entitled “Apparatus for Providing Rail-Based Vertical Short Takeoff and Landing and Operational Control,” each of the foregoing which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Field

The present disclosure relates generally to the fields of mechanical drive systems, and in one exemplary aspect, the present disclosure is directed to methods and apparatus for driving components associated with mobile craft such as vertical short takeoff and landing (VSTOL) aircraft.

### 2. Description of Related Technology

FIG. 1 illustrates a typical prior art linear drive system 100. As shown, this system includes a so-called “rack and pinion” approach, wherein a motive drive source such as a motor 102 drives a linear toothed rack 104 by virtue of a roller-based drive element 106, so as to convert rotational motion of the motor 102 to linear motion of the rack 104. The components shown in FIG. 1 are generally metallic (e.g., high-strength alloys), and as such both (i) require periodic lubrication and are comparatively heavy.

One general drawback of such prior art rack and pinion systems is their relatively high level of friction (and friction losses). Such friction reduces the longevity and reliability of such systems over time, and the losses create inefficiencies as far as power consumption for the motive source (e.g., electrical power, combustible fuel, etc.). Helical racks (i.e., those with the teeth forming a helical or angled pattern) generally offer quieter running at higher speeds, and also higher load carrying capability due to increased tooth contact area ratio relative to a non-helical configuration; however, each of the foregoing generally require lubrication apparatus to maintain them sufficiently lubricated, especially at high speeds.

Moreover, backlash (due the typically necessary level of clearance between the rack 104 and the driving “pinion” 106) can be problematic, especially in cases where transient loading is experienced; e.g., stop/start or fast/slow operational modes which change frequently. Such backlash can produce significant wear over time, thereby reducing efficiency and load capability of the mechanism with time if not constantly lubricated.

The foregoing limitations of prior art rack-and-pinion type drive systems are particularly evident in the context of applications where weight and reliability are critical, such as for use in aircraft. High reliability (a general prerequisite for any critical aircraft system) in rack-and-pinion systems effectively mandates a high level of lubrication, as well as very durable materials (such as the foregoing high-strength alloys). For instance, a broken rack tooth may render the mechanism inoperable (e.g., due to slippage/lack of engagement of the teeth by the pinion, or the broken tooth wedging itself in the mechanism and jamming it. Moreover, in the event of a tooth failure or other catastrophic failure during operation, there is generally no backup system available; especially in weight-sensitive applications such as aircraft, carrying a redundant system (e.g., a second rack and pinion mechanism) is weight-prohibitive.

The lubrication systems necessary to support operation of such high-strength components at high speed add appreciable weight to an already heavy system (e.g., via seals, the weight of lubricant), and any other ancillary components needed to effect lubrication). As such, these prior art approaches are not optimized for applications where both weight and reliability are critical.

Accordingly, improved solutions are required for applications such as e.g., VSTOL. Such improved solutions should ideally provide a reduced need for lubrication systems and components, and concurrently a high degree of reliability.

### SUMMARY

The present disclosure satisfies the aforementioned needs by providing, inter alia, improved methods and apparatus for driving components, such as within vertical short takeoff and landing (VSTOL) or other aircraft applications.

In a first aspect of the disclosure, a drive apparatus is described. In one embodiment, the drive apparatus comprises: at least one drive element comprising a plurality of roller elements disposed around a periphery of a rotatable member, the rotatable member configured to be driven by a motive force; and at least one driven element comprising a plurality of teeth configured to engage respective ones of the plurality of roller elements, the at least one driven element comprising an at least approximately circular shape.

In one variant, the drive apparatus is configured for use in a vertical short takeoff and landing (VSTOL) apparatus having at least one rotating ring comprising a plurality of airfoils disposed radially around an outer perimeter of the at least one rotating ring, the at least one rotating ring coupled to the at least one driven element.

In one implementation thereof, the at least one drive element comprises first and second drive levels, each of the first and second drive levels having a plurality of the roller elements disposed around a periphery of the rotatable member; and the at least one driven element comprises first and second driven elements, each of the first and second driven elements comprising a plurality of teeth configured to engage respective ones of the plurality of roller elements associated with the respective ones of the first and second drive levels.

In another variant, a common drive mechanism is used to drive two contra-rotating rings.

In another aspect of the disclosure, a vertical short takeoff and landing apparatus is disclosed. In one embodiment, the apparatus comprises one rotating ring with airfoils. In another embodiment, multiple (e.g., two) contra-rotating rings with attached airfoils are used, in conjunction with a power source, and a self-contained motor and drive system. The contra-rotating rings with attached airfoils rotate about the center axis of the apparatus and generate lift, and are each driven by the drive mechanism referenced above (e.g., upper and lower separate drive mechanisms.

In one variant, the capability of generating lift primarily from ambient air currents is introduced. This allows the vehicle to, inter alia, stay aloft with minimal or even no energy consumption, and utilize only minimal drive mechanism engagement.

In a further aspect of the disclosure, methods of operating the drive apparatus are described. In one embodiment, the method includes detecting failure of one of a plurality of drive levels, and selectively configuring another of the plurality of drive levels to engage in place of the failed level.

In another embodiment, the method includes detecting a load state for one of a plurality of drive levels, and selectively configuring another of the plurality of drive levels to engage in tandem with the engaged level so as to distribute or balance load across the levels.

In another aspect of the disclosure, a lift generating mechanism is described. In one embodiment, the mechanism comprises at least two contra-rotating rings having a plurality of airfoils disposed on each. In one variant, the airfoils may individually (or in unison) change pitch or attitude. In another variant, the airfoils may also extend radially from the rings so as to increase the effective diameter of the apparatus.

In another aspect, methods and apparatus for selective disengagement/re-engagement of one or more ring/driver component sets is disclosed. In one embodiment, the methods and apparatus use differential tooth sizing on rings, with selectively variable angular relationship between the individual rings. In another embodiment, clutched or “freewheeling” drive levels are used. In yet another embodiment, retractable rollers are utilized.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a perspective view of a prior art rack-and-pinion drive mechanism.

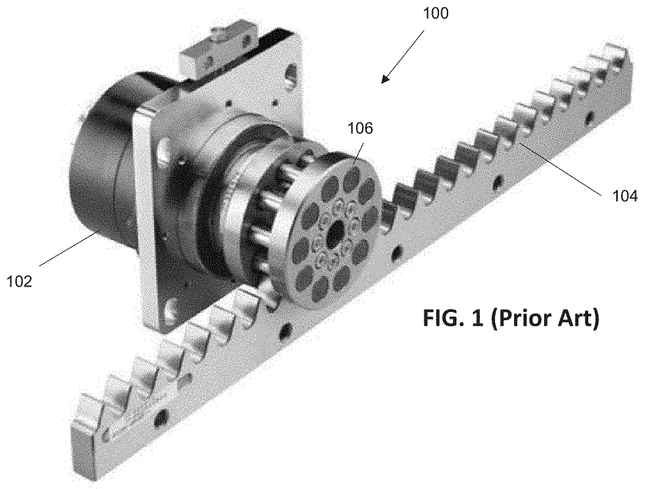

FIG. 2 is a perspective view of a first embodiment of a multi-level drive system according to the present disclosure.

FIG. 3 is a top plan view of the multi-level drive system of FIG. 2.

FIG. 3A is a graphical representation of load as a function of angular displacement (rotation) of the drive element for each drive level of the mechanism of FIGS. 2-3.

FIG. 3B is a top plan view (partial) of one embodiment of a drive element of FIGS. 2-3 illustrating an exemplary differential tooth configuration for different driven rings and their corresponding rollers.

FIG. 3C is a graphical representation of load as a function of angular displacement (rotation) of the drive element for each drive level of the mechanism of FIGS. 2-3 when configured for angular adjustment (e.g., unloading) of certain rings.

FIG. 3D is a top plan view (partial) of one embodiment of a drive element of FIGS. 2-3 illustrating an exemplary external rack-and-pinion arrangement for relative angular adjustment of one or more rings.

FIG. 3E is a top plan view (partial) of one embodiment of a drive element of FIGS. 2-3 illustrating an exemplary retractable roller configuration (one roller shown for simplicity).

FIG. 3F is a top plan view (partial) of one embodiment of a drive element of FIGS. 2-3 illustrating an exemplary configuration for different driven rings and their corresponding rollers, with one set of rollers retracted.

FIG. 4 is a perspective view of a first embodiment of a single-level drive system according to the present disclosure.

FIG. 5 is a perspective view of a second embodiment of a multi-level drive system according to the present disclosure.

FIG. 6 is a top plan view of the multi-level drive system of FIG. 5.

FIG. 7 is a perspective view of the lift mechanisms of one exemplary embodiment of a vertical short takeoff and landing (VSTOL) apparatus in accordance with principles presented in the disclosure provided herein.

FIG. 8 is a top plan view of the VSTOL apparatus of FIG. 7, illustrating the relationship between the drive mechanism and a ring with associated airfoils.

FIG. 9 is a bottom plan view of another embodiment of a VSTOL apparatus, having one or more drive mechanisms each engaging two rings with associated airfoils.

FIG. 10 is a perspective view of another exemplary embodiment of a drive apparatus in accordance with principles presented in the disclosure provided herein.

FIG. 11 is a close-up perspective view of the drive apparatus of FIG. 10, showing one of the drive elements and ring features in detail.

FIG. 12 is a perspective view of yet another exemplary embodiment of a drive apparatus in accordance with principles presented in the disclosure provided herein.

FIG. 13 is a top plan view of the drive apparatus of FIG. 12, showing one of the drive elements and ring features in detail.

FIG. 14 is a perspective view of another exemplary embodiment of a drive apparatus in accordance with principles presented in the disclosure provided herein.

FIG. 15 is a logical flow diagram illustrating one embodiment of a method of operating a multi-level drive system according to the present disclosure, so as to mitigate a component failure.

FIG. 16 is a logical flow diagram illustrating one embodiment of a method of operating a multi-level drive system according to the present disclosure, so as to effectuate load balancing.

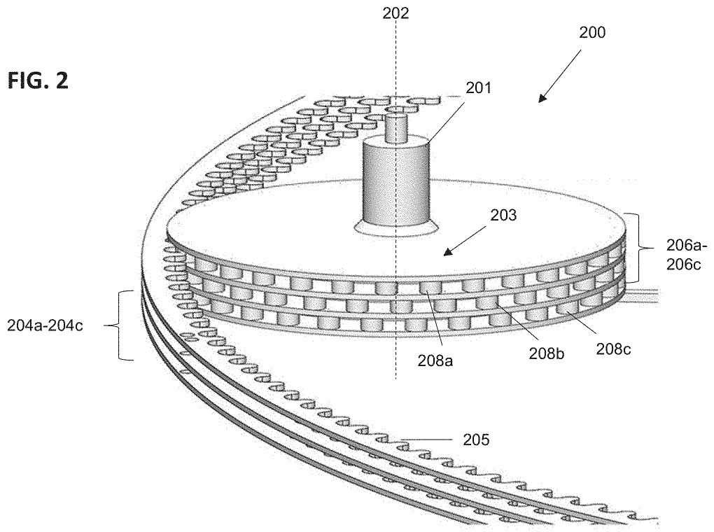

© FIGS. 2-16 Copyright 2019-2021 Radeus Laboratories. All rights reserved.

### DETAILED DESCRIPTION

Reference is now made to the drawings, wherein like numerals refer to like parts throughout.

### Overview

In one aspect, the present disclosure provides methods and apparatus for mechanically driving components in a desired direction, such as in a moving craft. In one embodiment, the craft comprises a vertical or short takeoff and landing (VSTOL) aircraft comprising one or more rotating rings having airfoils disposed around a periphery thereof. In one variant, the one or more rings are driven by a multi-level drive apparatus having a plurality of angularly offset (i.e., in azimuth) roller-based drive levels, and a plurality of corresponding angularly offset driven members (e.g., rings), the plurality of driven members coupled to e.g., the at least one rotating ring. Depending on configuration, one or more of the driven rings can be engaged with its corresponding drive level so as to achieve desired levels of load (and load balancing), reduced noise, and/or failure redundancy.

Advantageously, use of this arrangement provides enhanced reliability over prior art approaches, as well as opportunities for selective load balancing. Moreover, comparatively heavy lubrication components such as seals and liquid lubricants are obviated, and the drive components themselves can be fabricated at least partly from lighter weight materials, thereby also saving weight when applied to the host craft.

### Detailed Description of Exemplary Embodiments

Exemplary embodiments are now described in detail. While these embodiments are primarily discussed in the context of a manned or unmanned VSTOL aircraft or drones, it will be recognized by those of ordinary skill that the present disclosure is not so limited. In fact, the various aspects are useful for aircraft (whether vertical short takeoff and landing or otherwise) and other craft in a variety other contexts.

Furthermore, while the disclosure is discussed primarily in the context of generating lift in a gaseous fluid medium such as the earth's atmosphere, it will be recognized by those of ordinary skill that the architectures and principle disclosed herein could be readily adapted for use in other operating environments, such as liquids, with the discussion using gaseous mediums merely being exemplary.

It will also be recognized that while particular dimensions or angular relationships may be given for the apparatus or its components, the apparatus may advantageously be scaled to a variety of different sizes, depending on the intended application. For instance, the disclosure contemplates a small table-top or even hand-held variant which may be useful for e.g., drone usage. Likewise, a large-scale variant is contemplated, which may carry a living being such as a human, one or more sensors and even weapons (such as e.g., Hellfire precision guided munitions or the like), have greater loiter and altitude capabilities, etc. This design scalability is one salient advantage of the apparatus.

### Exemplary Drive Apparatus and Operation—

Referring now to FIG. 2, a first exemplary embodiment of a drive mechanism 200 for use in e.g., a VSTOL apparatus, is shown and described in detail. The drive mechanism of FIG. 2 generally includes three (3) driven rings 202a, 204b, 204c disposed in parallel, stacked relationship to one another, including an upper, middle and lower ring of common diameter and each having a plurality of teeth 205 formed on an inner periphery thereof. As used herein, the terms “upper”, “middle” and “lower” connote no special absolute relationship or orientation, and merely indicate relative positioning to one another (and in fact may be inverted, such as when the aircraft is inverted and the “lower” ring becomes the “upper” ring).

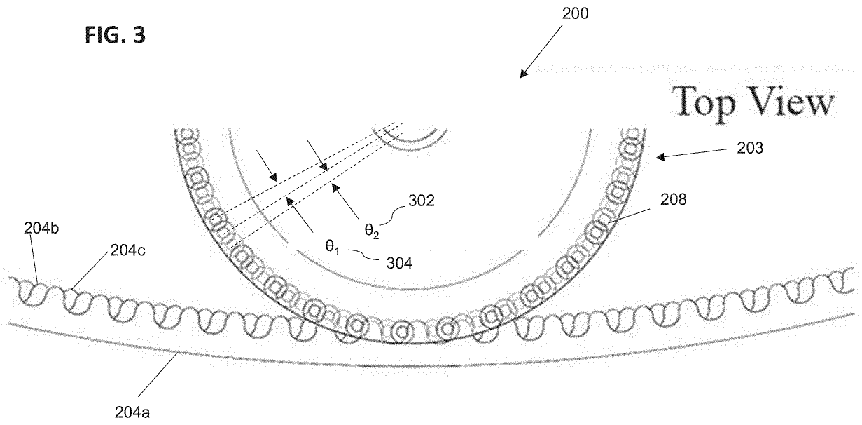

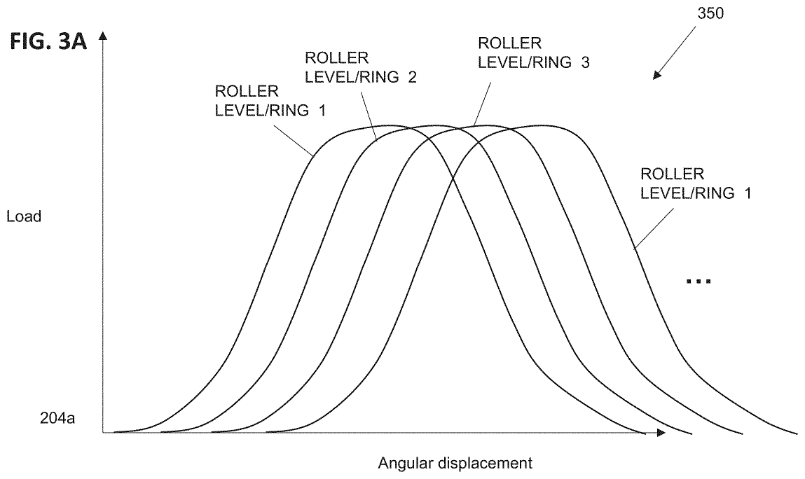

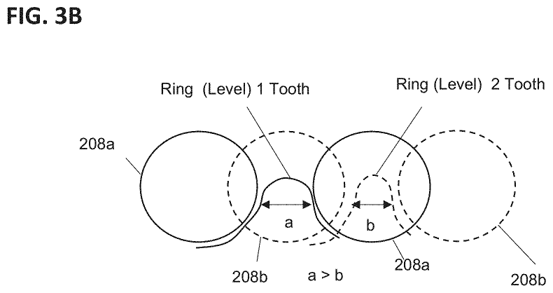

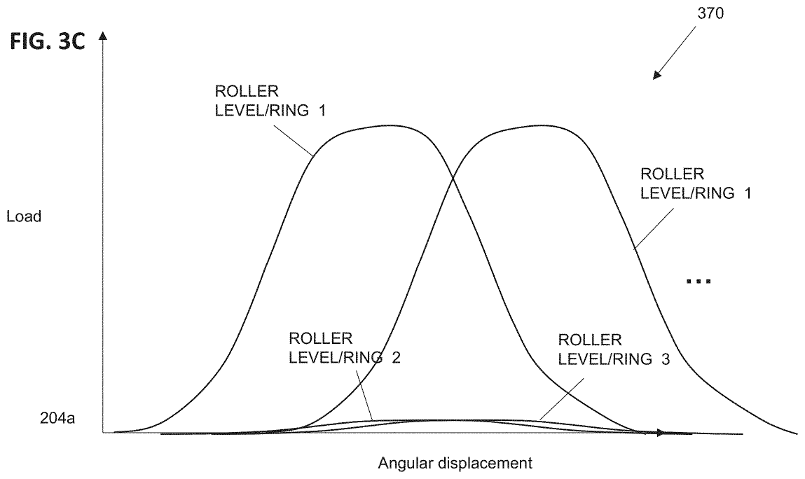

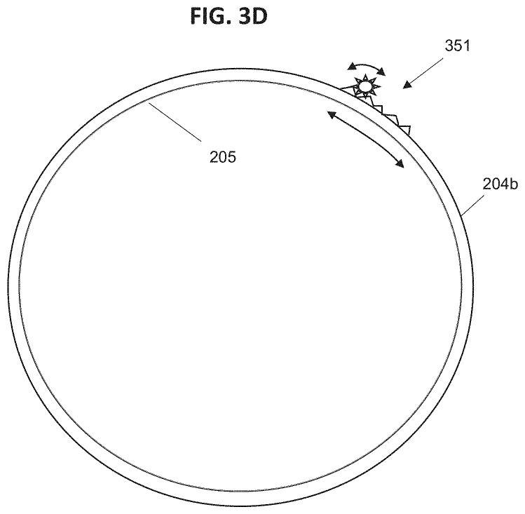

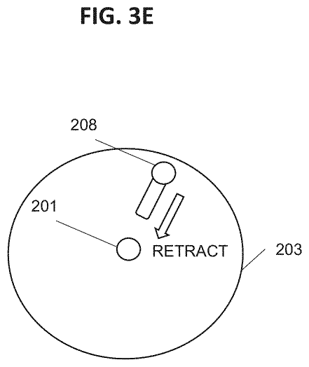

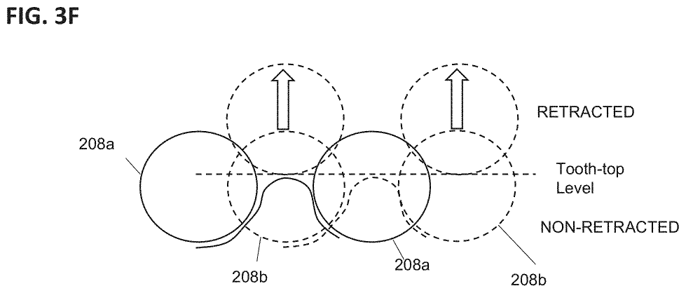

In one embodiment, the rings are effectively identical to one another, but as discussed in greater detail below, each is angularly offset from one another (i.e., rotated a prescribed number of degrees in azimuth such that the teeth 205 are also angularly offset relative to each other when viewed from above (see FIG. 3).

The rings 204 are driven by a corresponding multi-level drive element 203, which rotates around a central rotational axis 202 which is in one embodiment normal to the plane of the rings 204. The drive element is driven by e.g., a DC electric motor (not shown), and includes a plurality of levels 206a-206c corresponding to the plurality of rings 204. Each level 206 contains a plurality or respective rollers 208a-208c, which are each configured as roller-bearings in one embodiment. Use of roller bearings allows for inter alia, wear and load distribution and reduction of friction, which add longevity and reliability to the mechanism as a whole. Specifically, each roller 208 can roll as it engages corresponding surfaces of the ring teeth, and hence frictional movement of the (two) surfaces is minimized.

As can be appreciated, the relationship between the rollers 208 and the teeth 205 on any given level may be identical; e.g., the roller spacing centerline-to-centerline (as reflected by θ₁ 304 and θ₂ 302 in FIG. 3) is matched to the tooth spacing such that efficient power transfer occurs, and these spacings are both (i) identical around the periphery of the drive level 206 and the ring 204, and (ii) identical across levels and rings.

However, the present disclosure also contemplates embodiments where the cross-level spacings for both rollers (along with roller diameter) and teeth may vary, in effect providing a variable gear ratio for each different level.

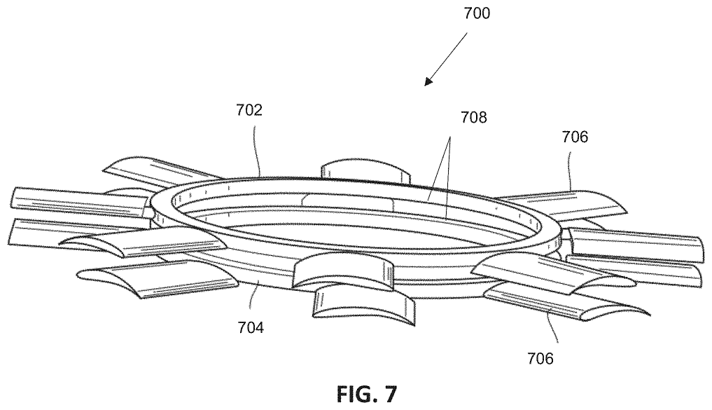

In the embodiment (shown in FIGS. 2 and 3) however, the uniform tooth and roller size/spacing across the multiple levels provides both (i) redundancy, and (ii) load distribution. Specifically, as each of the offset rollers 208 and their counterpart teeth 205 on each level are successively engaged as the drive element 203 rotates, some of the load on the rings (due to e.g., air resistance of airfoils; see FIGS. 7-9) is taken up by each ring/drive level set, and the load distributed or shared among the different drive level/ring teeth sets such that at any given point in time, load is distributed in varying proportions among two or more of the multiple levels. In effect, individual each tooth/roller set of a given level is 120-degrees out of phase from the other two. This relationship is exhibited in the plot 350 of FIG. 3A.

The foregoing design effectively provides additional surface area of engagement between the rings and rollers (as a whole), akin to a prior art helical approach, yet without the proportional friction produced by such helical arrangement. In the exemplary embodiment, the teeth 205 are “straight cut” to correspond to the perpendicular roller cross-section and axes of the respective drive element, and ring (and hence tooth) width may be adjusted by design (along with relative angular spacing or offset of the teeth and rollers) so as to provide the desired degree of engagement area for the calculated maximum load. As such, while a three-level design is shown in FIGS. 2 and 3, it will be appreciated that more levels may be utilized, such as e.g., a six-level design, incorporating e.g., thinner stacked rings 204 and thinner drive element levels 206.

It will also be appreciated that tooth shape or profile within the plane of the ring(s) 204 may be varied to provide desired performance and qualities. While a symmetric “bell curve” shape with circular cross-section troughs (corresponding to the circular cross-section of the rollers) is shown in FIG. 3, other shapes (including non-symmetric ones) may be desirable in some scenarios.

In some embodiments, the rings 204 (and even their corresponding drive rollers 208) can be fabricated from high-strength composite or polymeric material (e.g., Delrin® AF, which is a combination of PTFE fluorocarbon fibers uniformly dispersed in Acetal/Delrin resin). The PTFE (aka Teflon) adds inter alia, a “slipperiness” to the material, thereby further reducing lubrication requirements. Other materials may be used as well, such as e.g., other combinations of materials such as ETFE (Tefzel) and Polyoxymethylene (POM), and even ceramics (such as Zirconia Oxide (ZrO2)). Surface-hardening may also be employed where applicable to increase hardness and durability of e.g., ring teeth 205 and rollers 208. In that weight is critical, hardness is also critical, in that harder teeth/roller surfaces can utilize less material to produce the same “strength”, thereby also allowing for weight reduction.

In other embodiments, different ones of the “levels” of drive 203 and rings 204 may be selectively engaged or disengaged, for instance by (dynamically) varying the angular relationship of one or more of (i) the drive rings 204 to each other, and/or (ii) the drive levels 206 and rollers 208 to other levels/rollers of the same drive element 203 so as to effect a variety of desired functions. For example, it may be desirable to adjust the proportion of load being carried by each of the rings 204 in FIG. 3A, such as for reduced noise or friction. If e.g., the first ring 204a is rated to carry the full load of the mechanism, its teeth 205 alone may be used to carry the entire load by removing the rollers 208 of the other levels 206 of the drive element from contact with the other rings 204b, 204c. This removal from contact can be accomplished using any number of different approaches, including in one embodiment by slightly offsetting the angular relationship of the second and third rings (in effect, retarding their timing relative to the teeth of the first ring) within the tolerance of the teeth lash, such as via a variable friction element between the rings which allows the second and third rings 204b, 204c to slip slightly in azimuth relative to the first ring 204a, as driven by e.g., a gear drive (e.g., rack-and-pinion 351) disposed externally on the adjustable rings to rotate them angularly with respect to one another when frictionally released from one another but each held within a common circular “track” or guide (not shown)—see FIG. 3F). As such, the teeth of the second and third rings may have a varied profile (in the plane of the ring) with respect to the teeth 205 of the first ring 204a, including a greater degree of lash or “slop” (slightly narrower teeth) than the teeth of the first ring 204a (see FIG. 3B). This produces the load profile 370 of FIG. 3C (i.e., the first ring/drive level carrying effectively all load, and the other levels carrying little or none).

When engagement and load-carrying by all three rings is needed, the second and third rings can be “advanced” (and then retained in fixed relationship to each other and the first ring) such that their teeth contact their respective level of roller sets 208b, 208c, thereby causing them to carry increased load. This approach can obviously be applied to the remaining N−1 rings (after the first) of an N-ring system individually, or with the N−1 remaining rings ganged together and operating in unison for advancement/retarding of their relative timing. It will be appreciated that similar effect can be accomplished by using e.g., smaller diameter rollers on for instance the second and third drive levels 206 (in place of different tooth geometry), or a combination of the foregoing can be used.

In another approach, the rollers of any given level 206 of the drive mechanism 203 can be disengaged, such as where each level of the drive mechanism is independently rotatable. In this case, each unloaded level can “freewheel” on its axis of rotation 202 when not engaged (i.e., not mechanically coupled to drive shaft or other driven level(s) 206 of the drive element 203), and then when loading is desired, that level can be coupled (e.g., via friction clutch mechanism or other approach which enables selective coupling/uncoupling) such that the now-locked level carries load in tandem with others fixed coupled to the drive shaft. In this approach, no alternative tooth or roller geometry as in FIG. 3B is required from level to level, and no ring “slippage” or timing adjustment is needed.

In yet a further approach, the rollers of each selectively operable level 206 of the drive mechanism 203 can be configured for selective disengagement from their rings via retraction of the rollers radially toward the motive source drive shaft/axis 201 (see FIGS. 3E and 3F).

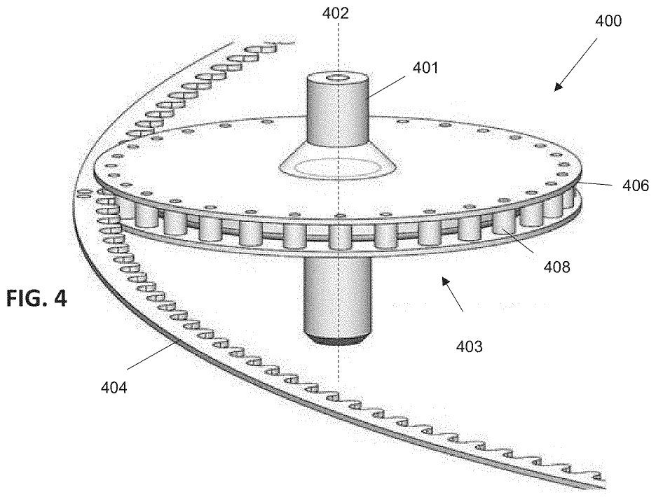

FIG. 4 is a perspective view of a first embodiment of a single-level drive system 400 according to the present disclosure. In this embodiment, a single level of engagement is used. This approach may be useful where e.g., one or more other disposed drive elements 403 is/are positioned at another location on the interior of the ring, such as diametrically opposed to a first one. As such, the load distribution and redundancy benefits are obtained via a common driven ring 204. This approach, while saving some weight in terms of elimination of a second (or third) ring 204, also is susceptible to a single-point ring failure (e.g., a cracked ring or broken tooth may render it inoperable). When additional drive elements 403 (not shown) are used, it also necessitates at very least a gearbox or some mechanism for providing motive force to the additional drive elements, thereby potentially adding weight and complexity.

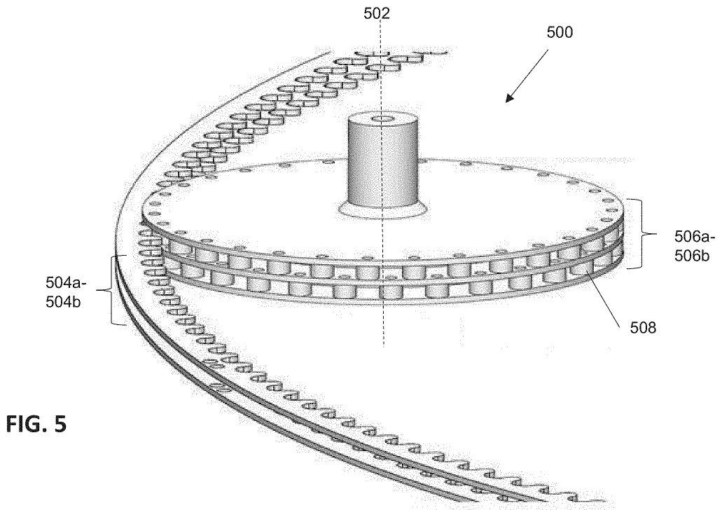

FIG. 5 is a perspective view of a second embodiment of a multi-level drive system according to the present disclosure. In this embodiment, only two levels of drive element 506a, 506b and two corresponding driven rings 504a, 504b are used. In some respects, this embodiment represents an optimization of (i) minimal drive requirements (one motor, no gearboxes, and only two levels of rollers 508), (ii) load sharing or distribution, by virtue of two rings each successively carrying varying fractions of the ring load, and (iii) minimal ring weight requirements, in that only two rings (versus three as in FIG. 2) are used. In such cases, higher strength materials maybe required as compared to the embodiment of FIG. 2, since each tooth is ostensibly carrying more load (for the same external ring loading) at any given time, and as such its shear stress, strength, etc. need to be higher. Moreover, ring deformation (i.e., the tendency of a ring 504 to go out of round under load) is to be considered.

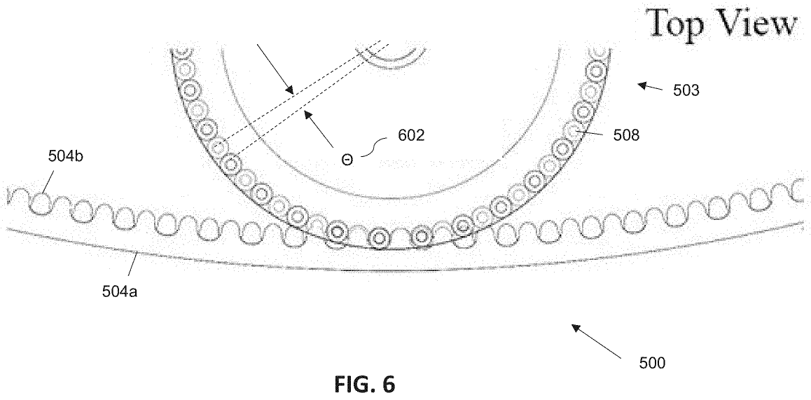

FIG. 6 is a top plan view of the multi-level drive system of FIG. 5. As shown, the angular offset 602 is adjusted such that each tooth/roller set of each level is 180-degrees out of phase with the other in terms of load assumption.

It will be appreciated that while the various embodiments shown and described herein utilize a drive mechanism and ring teeth disposed on an interior region of the rings, such mechanism may be disposed external to the rings (i.e., with the teeth and drive levels on an exterior periphery of the rings), and in fact combinations of interior//exterior drive may be used as well. In one such variant, each ring includes teeth on both an interior periphery (as in e.g., FIG. 2) and an exterior periphery (not shown), with respective single- or multi-level drive level drive elements 203 configured to engage each respectively. For instance, the outer drive element may remain engaged concurrently with the interior drive element (such that each driven ring is driven by forces applied to both its interior teeth and exterior teeth, or alternatively one set may either be (i) not actively driven but engaged, or (ii) not actively driven and disengaged from the ring, such as via a radial drive element retraction mechanism (not shown).

Moreover, the two drive elements may be driven from a common motive source (e.g., a common electrical DC motor), and may also be driven in a prescribed fixed relationship to one another (through e.g., a lightweight gearbox), or alternatively may be “clutched” such that some relative movement or slippage may occur.

Consider another such implementation, wherein two stacked rings 204 are utilized, one toothed on its interior periphery, and one toothed on its outer periphery. Respective drive elements 203 may be used therewith, each selectively engaged or disengaged depending on load, component integrity/failure status, or other considerations.

### Exemplary VSTOL Apparatus—

FIG. 7 is a perspective view of the lift mechanisms of one exemplary embodiment of a vertical short takeoff and landing (VSTOL) apparatus in accordance with principles presented in the disclosure provided herein. As shown, the VSTOL apparatus 700 generally comprises a plurality of rotating rings 702, 704 (which may be contra-rotating as described below), each having a plurality of airfoils 706 disposed around a periphery thereof. The drive system 200, 400, 500 is removed from view, as are other components, for clarity of illustration.

Each of the airfoils generally has a curved shape such that it is capable of generating lift while being rotated through the surrounding air. Accordingly, as the upper and lower rings of the apparatus 700 spin around a central axis, the airfoils create lift (or alternatively downdraft, or negative lift, depending on the orientation of the airfoils as discussed infra). Each of the airfoils includes a generally curved or rounded leading edge and a narrower trailing edge portion. In the embodiment illustrated, the upper airfoils curved leading edge is positioned such that the upper rotating ring will generate lift by rotating in a counterclockwise direction (when viewed from above). Conversely, the lower airfoils curved leading edge is positioned such that the lower rotating ring generates lift by rotating in the opposite direction (i.e. clockwise). While a specific configuration is shown, it is appreciated that the leading edges for the upper and lower airfoils could be reversed such that an opposite rotation (i.e. clockwise rotation for the upper airfoils and counterclockwise rotation for the lower airfoils) will generate lift for the VSTOL apparatus.

In operation, the VSTOL apparatus of FIG. 7 generates lift by counter-rotating the rings and thereby allowing for continuous movement of the airfoils. Through inter alia the Bernoulli Principle, lift is generated.

As the upper and lower rings rotate in opposite directions and are essentially identical in construction in this embodiment (albeit in a reversed orientation), the combined motion of the rings generates no net torque on the apparatus when the upper and lower rings are rotated at the same speed. This is useful in that additional rotors, or rotors oriented in an orthogonal orientation (such as that seen in conventional helicopters) are not necessary in order to provide counter rotation. In addition, by varying the relative speeds of the counter rotating rings, a net torque can be generated, thereby allowing the VSTOL apparatus to rotate about a central (vertical) axis, again without necessitating an additional rotor.

In the illustrated embodiment, each of the airfoils 706 is independently articulated, such as e.g., using mechanisms described in the previously incorporated prior patent applications. This articulation allows for control of lift, attitude, pitch, lateral translation, rotation, and other aspects.

In addition, the multiple rings allow for increased lift capability, because they allow for more points for lift generation. Furthermore, as will be appreciated later in the specification, the coordination of the upper and lower airfoil elements leads to a synergistic improvement of lift capacity. Considerations related to this coordination of upper and lower airfoils (including ring spacing, airfoil shape, rotational speed, etc.) can aid in effective airfoil/ring design that e.g., maximizes upward lift.

It can also be appreciated that advantages from gear reduction (e.g., between the output shaft of the drive source, such as a motor or engine, and the drive applied to the rings) can easily be leveraged using the contra-rotating ring design described herein. In fact, the rings themselves can act as the main reduction gears given that the drive system of the VSTOL apparatus is located entirely within the circumference of the rings.

It can also be appreciated that the airfoils can comprise flaps, slats, or other extensible control surfaces that can be expanded or contracted to change the shape of the airfoils. The change is shape can be used to reduce or increase the lift achieved through the airfoils. Moreover, deicing can be achieved by altering the shape of the airfoils, potentially loosening built-up ice.

In yet another variant, the airfoils are substantially deformable in shape via internal mechanisms. Unlike the “flap” variant referenced above (which basically exaggerates the shape of the airfoil by extending the tail portion outward so that the leading edge to tail edge distance increases), the actual curvature of the airfoil can be altered mid-flight so that the Bernoulli effect (and/or other aerodynamic properties) are altered as desired. In one implementation, the outer surface of the airfoils comprises a substantially pliable polymer “skin” laid over a frame, the latter being mechanically deformable in shape by way of one or more articulated joints. Yet other approaches will be recognized by those of ordinary skill given the present disclosure.

Other potential implementations may utilize airfoil flaps that can be extended or retracted to change the shape of the airfoils. Through this airfoil extension and contraction, the aerodynamic cross-section of the apparatus can be altered to facilitate lift via e.g., ambient air currents.

As yet another option, the airfoils may be constructed so as to have a changing pitch/curvature as a function of radial position. For example, in one such variant, the pitch or curvature of the airfoil near the root about which it rotates may be one value, while the curvature changes as the distal (outward) end of the airfoil is approached; i.e., as if one grasped the end of the airfoil and twisted it so as to distort its shape. Such varying curvature may provide desired attributes in certain applications; e.g., greater lift as a function of rotational or angular velocity.

A key advantage of the VSTOL apparatus is that is can also be operated in such that it utilizes air currents to generate lift. This leads to improved performance in both the duration that the apparatus can be deployed and the range over which it can operate. The disc shape of the rings and fuselage aide in overall glide and lift. Therefore, this VSTOL apparatus design is particularly well suited for operation based solely on air currents.

Lift is also generated in certain conditions by impingement of moving air against the upward or downward tilted airfoil exposed surface. This feature is particularly useful when the apparatus is in “loiter” mode, wherein the rings (and airfoils) are minimally rotating or not rotating, and the VSTOL apparatus is in effect acting somewhat like a kite. In such loiter mode, the operator (or onboard/remote computer controller) acts to maintain the attitude of the aircraft at a prescribed angle of attack relative to the prevailing winds, so as to generate sufficient lift to maintain the craft's altitude.

For extremely long-term operation, the motors/drive system driving the rings (and in some cases even articulating the airfoils) are turned off, and the VSTOL apparatus fully depends on air currents for lift and balance. However, with little more energy usage the pitch, extension, and expansion of the airfoils (as well as the position of aforementioned “centered” mass) can be adjusted to control the lift and balance of the VSTOL apparatus. This increases the flexibility of this operational mode.

Finally, the motors driving the rings can be placed in a low power consumption mode to further assist the ambient air currents in the generation of lift. Running the rotors would still lead to significant energy/fuel consumption. However, in an adjustable low power consumption mode, a wide range of air current speeds can be used to assist in the generation of lift. In this fashion, effective use of power and fuel economy can be achieved.

Hovering capabilities and low turning radii allow for operation of the VSTOL apparatus in a crowded airspace, or one with hostile countermeasures or munitions. For example, operation at low altitude in an urban environment will present numerous obstacles (buildings and power lines etc.). To avoid these obstacles, traditional fixed wing aircraft would have to travel too slowly to generate sufficient lift and still negotiate around these obstacles. Thus, the VSTOL apparatus is well suited for surveillance or tracking missions through such airspace. Similarly, when over hostile territory, the craft can readily “viff” (a maneuver utilized by e.g., Harrier VSTOL pilots to rapidly slow or accelerate sideways/upwards/downwards using vectored thrust nozzles) so as to avoid an incoming missile, projectiles, other aircraft, etc. This can be accomplished by, in one variant, rapidly shifting its center of mass to the desired side, or alternatively rapidly changing the pitch of the airfoils on one or both rings so as to rapidly change altitude.

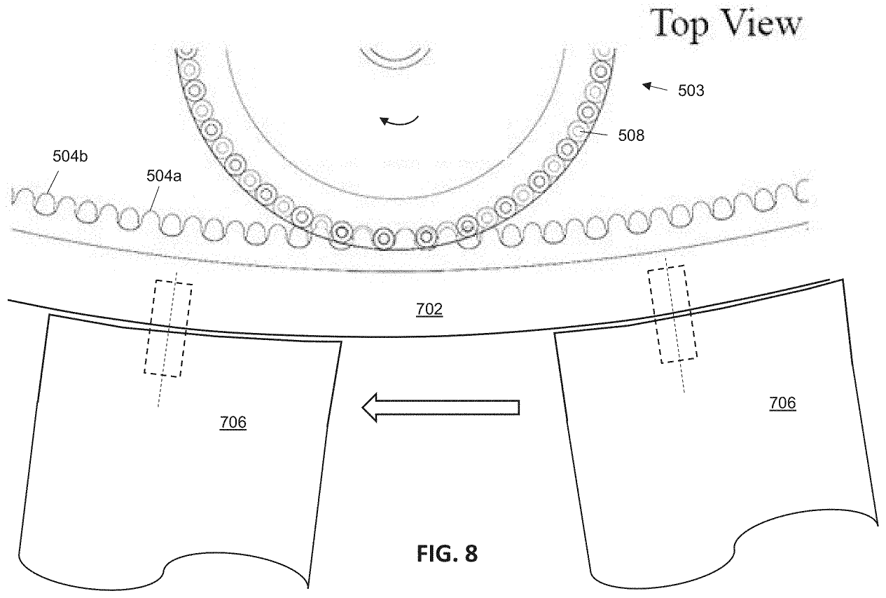

FIG. 8 is a top plan view of the VSTOL apparatus 700 of FIG. 7, illustrating the relationship between the drive mechanism 503 (the embodiment of FIG. 5 used for illustration) and a ring 702 with associated airfoils 706. As shown, the outer ring 702 is coupled to (or integral with) the drive rings 405a, 504b such that the airfoils 706 are moved through the surrounding air as the ring 702 rotates around a central axis (not shown).

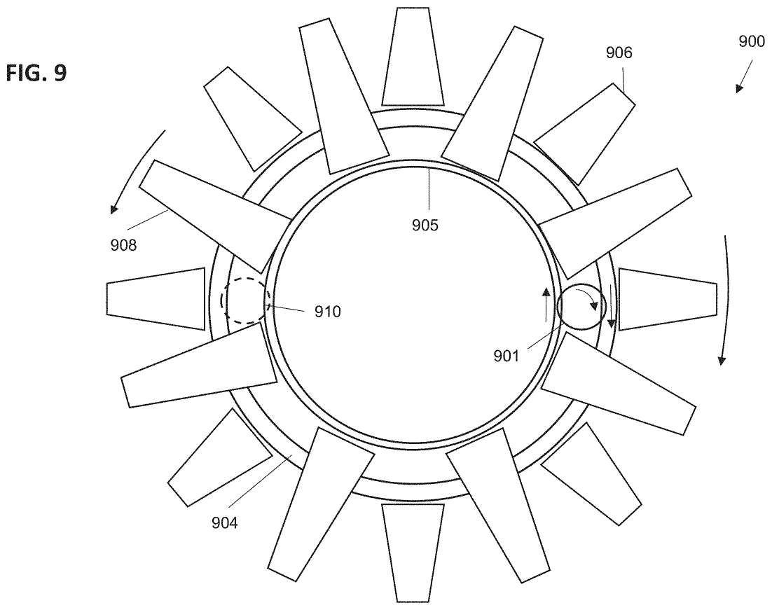

FIG. 9 is a bottom plan view of another embodiment of a VSTOL apparatus 900, having one or more drive mechanisms 901, 910 each engaging two “outer” or airfoil rings 904, 905 with associated airfoils. In this embodiment, the inner ring 905 is smaller diameter than the outer ring 904, and the drive element(s) 901, 910 disposed therebetween such that (i) teeth on the inner periphery of one or more drive rings (not shown) of the outer (airfoil) ring 904 engage the multi-level drive element of each mechanism 901, 910, and (ii) (ii) teeth on the outer periphery of one or more drive rings (not shown) of the inner (airfoil) ring 905 engage the multi-level drive element of each mechanism 901, 910. The inner and outer airfoil rings 905, 904 are offset vertically from one another such that each set of airfoils can e.g., contra-rotate relative to the other within offset planes. Hence, in one variant, a dual (drive) ring arrangement is used for each airfoil ring, thereby requiring a four-level drive element (i.e., when a single drive mechanism 901 is used). In another variant, each of two drive mechanisms 901, 910 has a two-level drive element; i.e., one to engage one drive ring of the top/outer airfoil ring 904, and one to engage on drive ring of the bottom/inner airfoil ring 905 in concert with the other mechanism engaging different rings of the top/bottom drive ring pairs. In this fashion, redundancy is provided, as is load distribution and also some level of ring distortion prevention in that the drive ring pairs are driven symmetrically at offset vertical levels.

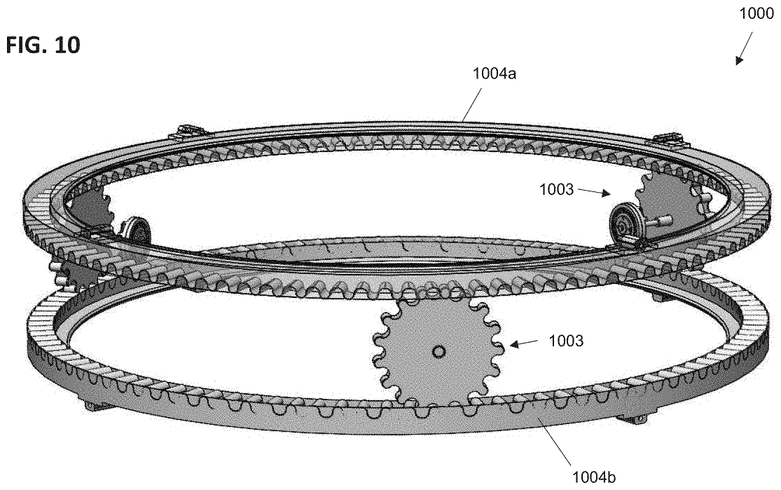

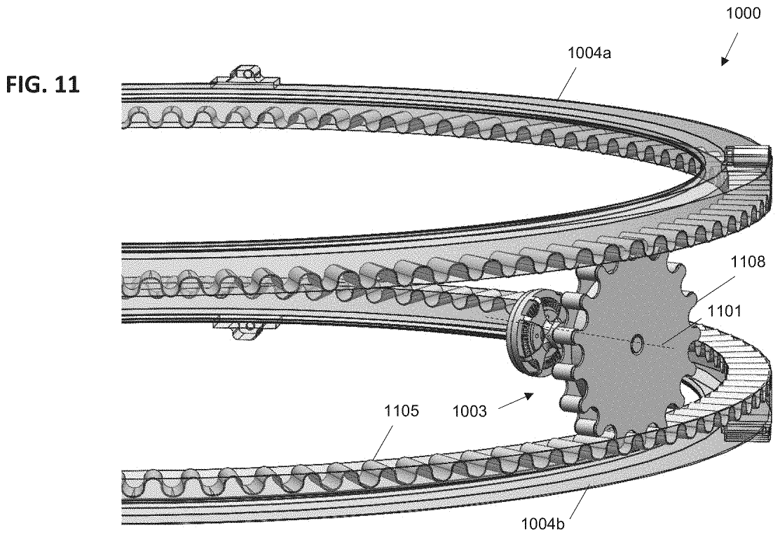

FIG. 10 is a perspective view of another exemplary embodiment of a drive apparatus 1000 in accordance with principles presented in the disclosure provided herein. In the illustrated embodiment, two counter-rotation driven rings 1004a, 1004b are driven by a series of three roller-equipped drive elements 1003 at 120-degree spacings from one another in azimuth. It will be appreciated that while the drive elements 1003 are shown as being “single row” (see FIG. 11, wherein a single row of roller “teeth” 1108 engage a single row of ring teeth 1105, redundancy may be obtained through use of e.g., a second row of ring teeth disposed concentric and coplanar with the first, along with a concurrent additional row of drive rollers 1108 on the drive element 1003. As previously described, the different drive element “levels” (in this case disposed radially with each other along each drive element shaft 1101) can also be clutched or selectively rotatable (e.g., can “freewheel” when selectively decoupled from the drive element shaft or the other level of the drive element), such as to reduce friction and/or noise at low loads,

It will be recognized by those of ordinary skill that when using such a concentric ring approach, one or both of teeth spacing and number of teeth (as well as corresponding roller spacing as measured along a circumferential arc between rollers) must be varied so as to accommodate the increased radius (and hence circumference) of each successive ring moving outward from the center. In one variant, a cylindrical multi-level drive element is used (not shown), wherein constant roller spacing between levels is used to correspond to constant tooth size and spacing on each ring, with each ring simply having varying numbers of teeth based on its circumference. In other embodiments, tooth geometry and roller spacing are varied, such that each ring has different characteristics in terms of e.g., load capability, friction, etc. (for instance, tooth spacing and roller spacing are increased or decreased as ring radius increases). Myriad other variants will be recognized by those of ordinary skill given the present disclosure.

FIG. 11 is a close-up perspective view of the drive apparatus 1000 of FIG. 10, showing one of the drive elements 1003 and ring features in detail.

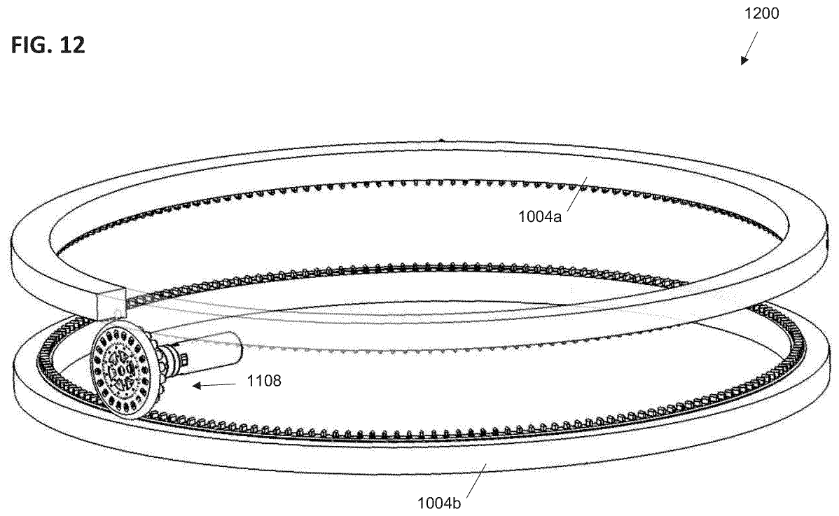

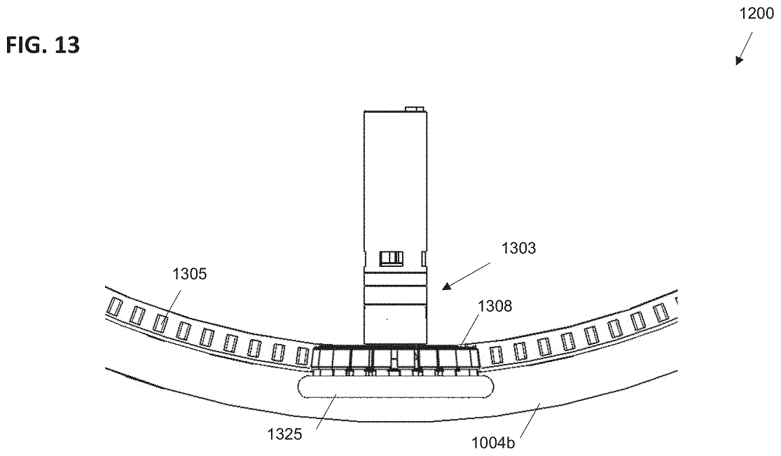

FIG. 12 is a perspective view of yet another exemplary embodiment of a drive apparatus 1200 in accordance with principles presented in the disclosure provided herein. In this embodiment, a different ring tooth shape 1305 is utilized (e.g., a more square-cut tooth profile with punctuated interstices) which engages with corresponding rollers 1308 (FIG. 13). And roller/spacer element 1325 is used to help maintain desired contact/mesh spacing between the ring(s) 1004 and drive elements 1303. As with the embodiment of FIGS. 11-12, one or more concentric rings (and drive roller levels) may be used if desired, such as for redundancy or additional load carrying capability.

FIG. 13 is a top plan view of the drive apparatus 1200 of FIG. 12, showing one of the drive elements 1303 and ring features in detail.

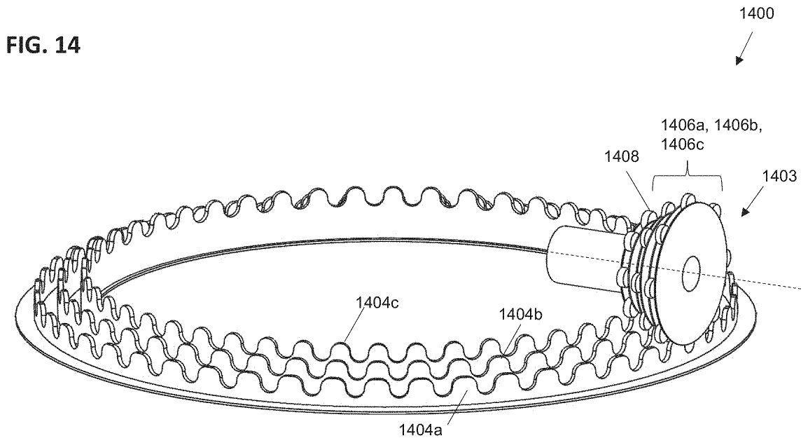

FIG. 14 is a perspective view of another exemplary embodiment of a drive apparatus 1400 in accordance with principles presented in the disclosure provided herein. In this embodiment, concentric rings 1404a, 1404b, 1404c are used, yet each successive ring varies in overall height as shown. A corresponding conic drive element 1403 is used, with corresponding levels 1406a, 1406b, 1406c of rollers 1408 which engage their corresponding concentric ring. This approach provides, inter alia, a degree of lateral (radial) stability; i.e., the rings 1404 are prevented from at least outward movement by the conic shape of the drive element and its levels. It will be appreciated that in some embodiments (not shown), the height of each ring 1404 may be configured to be selectively varied relative to its drive level 1406, such that a ring/drive level pair can be selectively engaged and disengaged generally as described previously herein, e.g., as load varies, components fail, to mitigate noise or friction, etc. Similarly other engagement/disengagement mechanism (such as e.g., clutched or freewheeling drive levels 1406) can also or alternatively be utilized. As noted with the “concentric” variants of the embodiments described relative to FIGS. 10-13 above, roller spacing, tooth spacing/profile, and/or other attributes may be varied as a function of level/ring circumference.

It will also be appreciated that in any of the “dual airfoil ring drive” variants discussed above (i.e., those of FIG. 9, 10-11, 12-13, and/or 14), the use of concentric or redundant drive rings within the mechanism may be asymmetric with respect to the upper and lower airfoil rings. For instance, the upper airfoil ring coupled to the driven ring 1004a of FIG. 10. May utilize a single level of ring/drive (no redundancy), while the lower airfoil ring 1004b may have redundancy (e.g., two concentric coplanar driven rings engaged to two respective drive levels 1006. The second drive level is in effect uncoupled to a concentric row of the upper ring (since there is only one driven ring 1004 for that airfoil ring).

### Methods of Operation

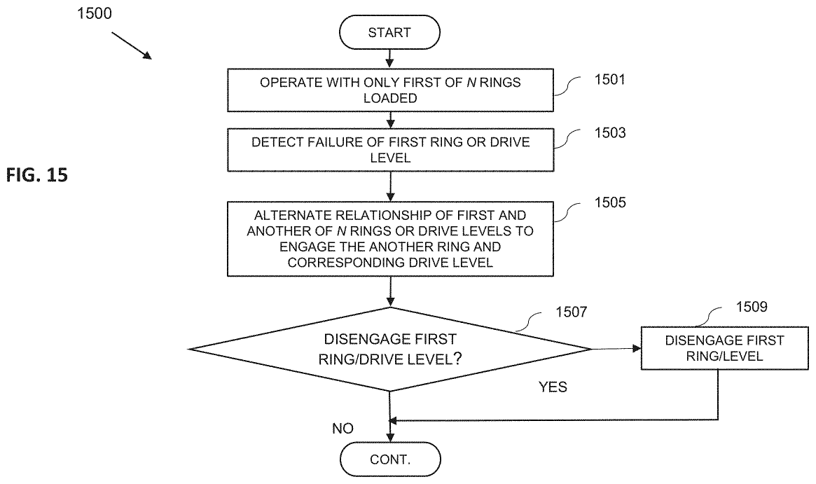

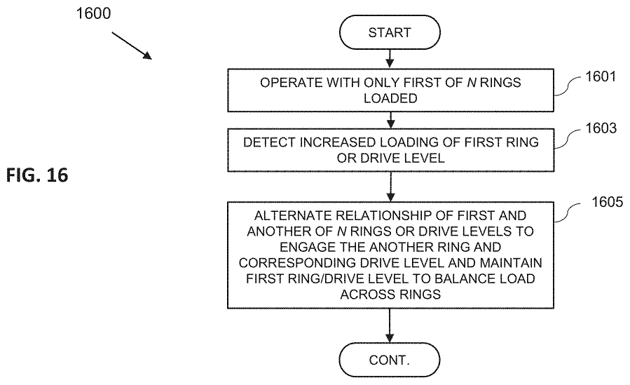

Referring now to FIGS. 15 and 16, methods of operation of the exemplary drive mechanism (e.g., those mechanisms 200, 500 of FIGS. 2 and 5 respectively), described herein are now discussed.

In the method 1000 of FIG. 15, per step 1501, the drive mechanism is operated with only a subset (e.g., a first of three) of the drive levels/rings engaged and carrying load. For instance, one or both of the second/third driven rings 204b, 204c of the embodiment of FIG. 2 may be “disengaged” from carrying load, such as using one or more of the adjustment or disengagement mechanisms previously described.

At step 1503, a drive component or system failure is detected (such as failure of a driven ring 204 or drive level 206), via e.g., vibration sensing, noise sensing, reduction in outer ring 702, 704 angular velocity, acceleration (consistent with e.g., instability or vibration), motor current draw, and/or other mechanism. If the failure is not catastrophic (e.g., a broken tooth wedges itself in the gearing/drive element such that further operation is impossible), then the failed ring/drive level can be “swapped out” for another (step 1505) by e.g., advancing one or more of the unloaded rings in relative timing, extending retracted second/third level rollers, de-clutching the first drive level from the drive shaft, etc. as previously described. For instance, if a tooth breaks off of the first ring 204a, then that ring can be retarded (or other advanced) so as to reduce or eliminate load on the broken ring. It will be appreciated that in the case of a static (non-dynamically variable) embodiment with none of the above-described adjustment/retraction features, this process occurs effectively automatically, since all of the N rings are engaged at least to some level constantly, and hence loss of a few sequential teeth on the first ring will result in, when that region of the ring reaches the drive element, load being assumed by the remaining ones of the N−1 remaining rings.

At steps 1505 and 1507, the damaged or failed ring may also be “disengaged” if desired (after the e.g., N−1 other rings are engaged) using the same type of approach as above; e.g., retraction of its rollers, retarding of its relative angular position/timing, etc., depending on how the drive mechanism is configured (e.g., with additional lash on its teeth, retractable rollers, clutch drive mechanism levels, etc.). Alternatively, the failed ring may simply be left to operate (albeit in reduced capability depending on the type of failure).

It will be appreciated that rings 204 or other components may be selectively retired due to e.g., wear as well. For instance, where the teeth 205 of a ring 204 wear or lose shape over time due to normal loading, the ring can be selectively reduced in load or even completely unloaded. As such, a form of wear leveling can be achieved; in the event that e.g., three given rings 204a, 204b, 204c of a drive mechanism wear unevenly, they can be increasingly loaded/unloaded commensurate with their relative wear. For example, if Ring 1 wears much more heavily than Ring 2, which wears more heavily than Ring 3 (for whatever reason), the rings can be adjusted slightly in relative timing/azimuth so that Ring 3 assumes most load, Ring 2 assumes the next highest load, and Ring 1 the least, so as to balance the wear more evenly.

In the method 1600 of FIG. 16, per step 1601, the drive mechanism is operated with only a subset (e.g., a first of three) of the N drive levels/rings engaged and carrying load. For instance, one or both of the second/third driven rings 204b, 204c of the embodiment of FIG. 2 may be “disengaged” from carrying load, such as using one or more of the adjustment or disengagement mechanisms previously described.

At step 1603, a need to increase or distribute loading to others of the rings 204 is detected (such as a load increase fed back through the airfoils, meeting a stress limit on the solo operating ring 204, etc.) via e.g., reduction in outer ring 702, 704 angular velocity, motor current draw, output of a stress/strain sensor on the loaded ring, increase in motor RPM demanded (e.g., via a control system input to increase rotational RPM), and/or other mechanism. The non-engaged ring/drive level(s) can be engaged (step 1605) by e.g., advancing one or more of the unloaded rings in relative timing, extending retracted second/third level rollers, de-clutching the first drive level from the drive shaft, etc. as previously described. It will be appreciated that in the case of a static (non-dynamically variable) embodiment with none of the above-described adjustment/retraction features, this process occurs effectively automatically, since all of the N rings are engaged at least to some level constantly, and hence load is naturally distributed effectively equally across the different rings under all load conditions, especially since each driven ring 204 is coupled to an outer airfoil ring 702, 704 and hence under load.

It will be recognized that while certain aspects of the disclosure are described in terms of a specific sequence of steps of a method, these descriptions are only illustrative of the broader methods described herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features as applied to various embodiments, it will be understood that various omissions, substitutions, and changes in the form and details of the device or process illustrated may be made by those skilled in the art. The foregoing description is of the best mode presently contemplated of carrying out the principles and architectures described herein. This description is in no way meant to be limiting, but rather should be taken as illustrative of the general principles of the disclosure. The scope of the invention should be determined with reference to the claims.

What is claimed is:

1. A drive apparatus, comprising:
at least one drive element comprising a plurality of roller elements disposed around a periphery of a rotatable member, the rotatable member configured to be driven by a motive force; and
at least one driven element comprising a plurality of teeth configured to engage respective ones of the plurality of roller elements, the at least one driven element comprising an at least approximately circular shape.

2. The drive apparatus of claim 1, wherein the drive apparatus is configured for use in a vertical short takeoff and landing (VSTOL) apparatus having at least one rotating ring comprising a plurality of airfoils disposed radially around an outer perimeter of the at least one rotating ring, the at least one rotating ring coupled to the at least one driven element.

3. The drive apparatus of claim 1, wherein the VSTOL apparatus is configured to operate without a lubrication system for the drive operates at least while in flight.

4. The drive apparatus of claim 2, wherein:
the at least one drive element comprises first and second drive levels, each of the first and second drive levels having a plurality of the roller elements disposed around a periphery of the rotatable member; and
the at least one driven element comprises first and second driven elements, each of the first and second driven elements comprising a plurality of teeth configured to engage respective ones of the plurality of roller elements associated with the respective ones of the first and second drive levels.

5. The drive apparatus of claim 4, wherein the drive apparatus is configured to selectively engage either (i) only one of the first and second drive levels, or (ii) both of the first and second drive levels, based at least on a desired level of at least one of a) friction reduction, or b) load carrying capability.

6. A vertical short takeoff and landing (VSTOL) apparatus, comprising
at least two contra-rotating rings each comprising a plurality of airfoils;
an electrical power source; and
a motor and drive system served by the electrical power source;
wherein the at least two contra-rotating rings rotate about a center axis of the VSTOL apparatus and generate lift using at least the plurality of airfoils, and are each driven by the motor and drive system.

7. The VSTOL apparatus of claim 4, wherein the motor and drive system comprises a plurality of gear elements disposed orthogonal to both a first plane of rotation of a first one of the at least two contra-rotating rings, and a second plane of rotation of a second one of the at least two contra-rotating rings.

8. The VSTOL apparatus of claim 7, wherein:
the motor and drive system comprises first and second drive levels;
each of the plurality of gear elements comprises a plurality of the roller elements disposed around a periphery of each of the plurality of gear elements, the plurality of roller elements arranged in (i) a first group corresponding to the first drive level, and (ii) a second group corresponding to the second drive levels, the first and second groups of roller elements disposed at different distances from an axis of rotation of the contra-rotating rings; and
each of the first and second drive levels comprise a plurality of teeth configured to engage respective at least ones of the plurality of roller elements associated with the plurality of gear elements.

9. A method of operating a drive mechanism of a vertical short takeoff and landing (VSTOL) apparatus, the drive mechanism comprising multiple selectively engagable levels of coupling to one or more rotating rings of the VSTOL apparatus, the method comprising:
operating the drive mechanism under a first load condition such that only a single one of the multiple selectively engagable levels of coupling is engaged to the one or more rotating rings so as to mitigate friction caused by the engagement; and
operating the drive mechanism under a second load condition such that two or more of the multiple selectively engagable levels of coupling are engaged to the one or more rotating rings so as to increase a load-carrying capacity of the VSTOL apparatus.
